(19) United States
(12) Patent Application Publication
(10) Pub. No.: US 2021/0366284 A1
(43) Pub. Date: Nov. 25, 2021

(54) INTERNET OF VEHICLES SYSTEM FOR DYNAMICALLY MARKING RISK AREA AND METHOD THEREOF

(71) Applicants: Inventec Appliances (Pudong) Corporation, Shanghai (CN); Inventec Appliances Corp., New Taipei City (TW); Inventec Appliances (Shanghai) Co., Ltd., Shanghai (CN); Inventec Appliances (JiangNing) Corporation, Nanjing (CN)

(72) Inventors: Yuan-Hsi YEN, New Taipei City (TW); Yu-Wei LIN, New Taipei City (TW); Min-Chen CHEN, New Taipei City (TW)

(21) Appl. No.: 16/986,243

(22) Filed: Aug. 5, 2020

(30) Foreign Application Priority Data
May 22, 2020 (CN) 202010441598.3

(51) Int. Cl. G08G 1/16

(52) U.S. Cl. CPC G08G 1/163; G08G 1/166

(57) ABSTRACT

An internet of vehicles system for dynamically marking risk area includes a cloud server communicating with a vehicle system. The cloud server includes a communication module, a planning module, a computation module, and a determination module. The communication module is configured to receive vehicle information from the vehicle system. The planning module is configured to formulate a dynamic risk area range according to a vehicle position of the vehicle information. The calculation module is configured to calculate a risk factor coefficient corresponding to the vehicle information and a risk intensity corresponding to the dynamic risk area range. The determination module is configured to determine whether the risk intensity is greater than or equal to a preset threshold value. The communication module notifies a warning to the vehicle system that the risk intensity of the dynamic risk area range is greater than the preset threshold value.

### RELATED APPLICATIONS

This application claims priority to China Application Serial Number 202010441598.3, filed May 22, 2020, which is herein incorporated by reference.

### BACKGROUND

### Field of Invention

The present disclosure relates to an internet of vehicles system and a method for dynamically marking risk area.

### Description of Related Art

The statements in this section merely provide background information related to the present disclosure and do not necessarily constitute prior art.

With the vehicles becoming universal, many countries start to be involved in the research of finding ways to improve driving safety. Many safety assistance systems appear, such as advanced driver assistance systems (ADASs) and risk warning systems. Some systems can accurately locate events (e.g., slow cars, slippery roads, road potholes) detected by sensors in the vehicle at the exact location of the lane, and transmit the information to a cloud computing center. In this way, the cloud computing center may transmit and share the information with other vehicles to achieve the benefit of risk warnings. Although the above method has a (pre)warning function, there are often cases where warnings are too frequent in the current situation when there are too many road emergencies.

### SUMMARY

In view of this, one objective of the present disclosure is to propose a warning system and a method that can substantially achieve issuing warnings on road risks, which can reduce or eliminate the situation in which drivers are disturbed by the warnings.

According to some embodiments of the present disclosure, an internet of vehicles system for dynamically marking risk area is provided. The internet of vehicles system at least includes a cloud server configured to communicate with a vehicle system. The cloud server includes a communication module, a planning module, a calculation module, and a determination module. The communication module is configured to receive vehicle information from the vehicle system, and the vehicle information includes a vehicle position. The planning module is configured to formulate a dynamic risk area range according to the vehicle position, and the dynamic risk area range moves synchronously with the vehicle position. The calculation module is configured to calculate a plurality of risk factor coefficients and to calculate a risk intensity corresponding to the dynamic risk area range. One of the risk factor coefficients corresponds to the vehicle information, and the risk intensity is formed by weighted sum of the risk factor coefficients. The determination module is configured to determine whether the risk intensity is greater than or equal to a preset threshold value. When the risk intensity is greater than or equal to the preset threshold value, the communication module notifies a warning to the vehicle system that the risk intensity of the dynamic risk area range is greater than the preset threshold value.

According to some embodiments of the present disclosure, a method for dynamically marking risk area is provided. The method includes: receiving vehicle information from a vehicle system; calculating a plurality of risk factor coefficients, and at least one of the plurality of the risk factor coefficients corresponding to the vehicle information; formulating a dynamic risk area range according to a vehicle position of the vehicle information, and the dynamic risk area range moving synchronously with the vehicle position; calculating a risk intensity corresponding to the dynamic risk area range, the risk intensity being formed by weighted sum of the risk factor coefficients; determining whether the risk intensity is greater than or equal to a preset threshold value, and notifying a warning to the vehicle system that the risk intensity of the dynamic risk area range is greater than the preset threshold value.

By the technical solution of formulating a dynamic risk area range, integrating various risk information within the dynamic risk area range, and determining whether the risk intensity is greater than a preset threshold, the embodiments of the present disclosure as mentioned at least substantially achieve the road risks warning which can reduce or eliminate the situation in which drivers are disturbed by the warnings.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic block diagram of an internet of vehicles system for dynamically marking risk area according to some embodiments of the present disclosure;

FIG. 2A is a schematic diagram of a dynamic risk area range according to some embodiments of the present disclosure;

FIG. 2B is a schematic diagram of the dynamic risk area range moving synchronously with the vehicle system in some embodiments of the disclosure;

FIG. 3 is a schematic block diagram of the internet of vehicles system for dynamically marking risk area according to some embodiments of the present disclosure;

FIG. 4 is a block diagram illustrating vehicle systems which communicate with the cloud server via edge servers according to some embodiments of the present disclosure; and

FIG. 5 is a schematic flowchart of a method for dynamically marking risk area according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In various embodiments, description is made with reference to figures. However, certain embodiments may be practiced without one or more of these specific details, or in combination with other known methods and configurations. In the following description, numerous specific details are set forth, such as specific configurations, dimensions, and processes, etc., in order to provide a thorough understanding of the present disclosure. Reference throughout this specification to “one embodiment,” “an embodiment”, “some embodiments” or the like means that a particular feature, structure, configuration, or characteristic described in connection with the embodiment is included in at least one embodiment of the disclosure. Thus, the appearances of the phrase “in one embodiment,” “in an embodiment”, “in some embodiments” or the like in various places throughout this specification are not necessarily referring to the same embodiment of the disclosure. Furthermore, the particular features, structures, configurations, or characteristics may be combined in any suitable manner in one or more embodiments.

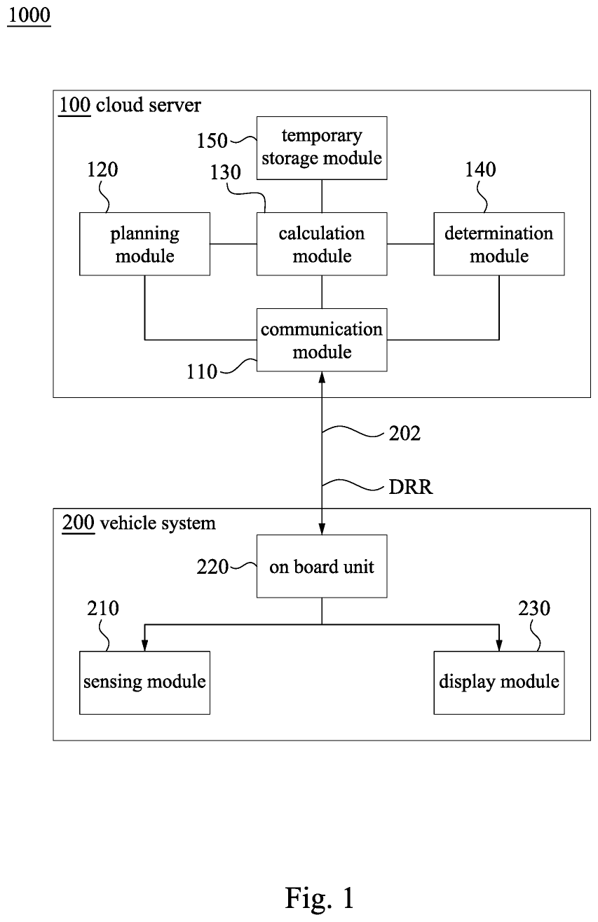

Reference is made to FIG. 1. FIG. 1 is a schematic block diagram of an internet of vehicles system 1000 for dynamically marking risk area according to some embodiments of the present disclosure. The internet of vehicles system 1000 at least includes a cloud server 100 configured to communicate with a vehicle system 200. The cloud server 100 includes a communication module 110, a planning module 120, a calculation module 130, and a determination module 140. The communication module 110 is configured to receive vehicle information 202 from the vehicle system 200. The vehicle information 202 at least includes a vehicle position. The planning module 120 is configured to formulate a dynamic risk area range DRR according to the vehicle position, and the dynamic risk area range DRR moves synchronously with the vehicle position. In other words, the dynamic risk area range DRR is bound to a designated vehicle system 200, and a risk of a surrounding area where the vehicle system 200 goes through is specifically evaluated.

The calculation module 130 is configured to calculate a plurality of risk factor coefficients and to calculate a risk intensity corresponding to the dynamic risk area range DRR as mentioned. At least one of the risk factor coefficients corresponds to the vehicle information 202, and the risk intensity is formed by weighted sum of the risk factor coefficients. The determination module 140 is configured to determine whether the risk intensity is greater than or equal to a preset threshold value. The preset threshold value may be determined by a manager of the internet of vehicles system 1000 according to official statistical information on occurred traffic accidents, or determined by a statistical big data according to long-term operation of the internet of vehicles system 1000, but should not be limited thereto. When the risk intensity is greater than or equal to the preset threshold value, the communication module 110 notifies a warning to the vehicle system 200 that the risk intensity of the dynamic risk area range DRR is greater than the preset threshold value.

In some embodiments, the cloud server 100 further includes a temporary storage module 150. The temporary storage module 150 is connected to the calculation module 130 and is configured to provide vehicle information of another vehicle to the calculation module 130, so that the calculation module 130 can integrate and calculate to derive the risk intensity corresponding to the dynamic risk area range DRR. In other words, after receiving the vehicle information 202 of the vehicle system 200, the calculation module 130 may request the temporary storage module 150 to provide real-time vehicle information of other vehicles in the dynamic risk area range DRR and integrate them to calculate the risk intensity. The way of integrated calculation as mentioned is only an example and should not limit the scope of the present disclosure. In some embodiments, the above function originally performed by the temporary storage module 150 may be achieved merely by the calculation module 130.

In some embodiments, the vehicle system 200 includes a sensing module 210 and an on board unit 220 (OBU). The sensing module 210 is configured to sense various data of the vehicle to which the vehicle system 200 belongs and to generate the vehicle information 202. The on board unit 220 is connected to the sensing module 210 and is configured to transmit the vehicle information 202 to the cloud server 100 and to receive the dynamic risk area range DRR and the risk intensity from the cloud server 100. In some embodiments, the sensing module 210 includes a vehicle speed sensing unit, a tracking system, a light switch sensing unit, a global positioning system (GPS) module, an acceleration sensing unit, or a camera unit. The vehicle speed sensing unit is configured to sense a vehicle speed of the vehicle (i.e., the host vehicle) to which the vehicle system 200 belongs. The tracking system is configured to sense an emergency braking of the host vehicle. The light switch sensing unit is configured to sense whether the host vehicle switches on a direction light when the host vehicle changes lanes, and whether the headlight of the host vehicle is on. The global positioning system module is configured to locate a position of the vehicle system 200. The acceleration sensing unit is configured to sense an acceleration of the vehicle. The camera unit is configured to record road conditions in real time. These units, modules and systems for sensing various parameters of the vehicle and real-time driving conditions can be installed as required, according to legal requirements, or according sensing items pre-specified by the internet of vehicles system 1000. In some embodiments, the vehicle system 200 further includes a display module 230, which is connected to the on board unit 220 and is configured to display a warning that the risk intensity of the dynamic risk area range DRR is greater than the preset threshold.

Some exemplary illustrations are provided as follows, but the illustrations do not limit the scope of the present disclosure.

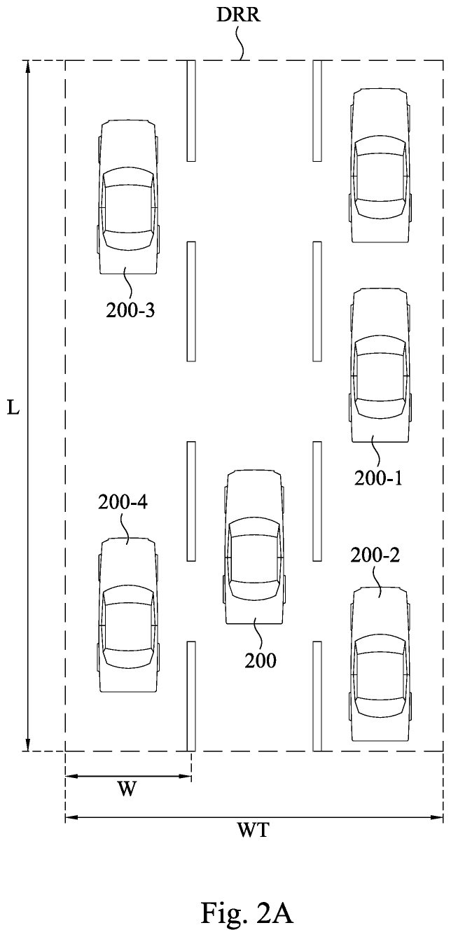

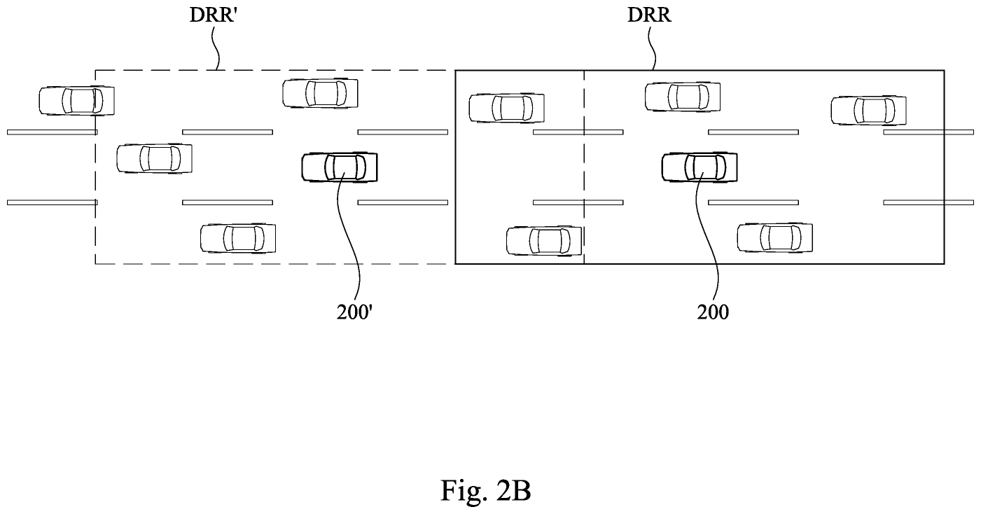

Reference is made to FIG. 2A for an example which illustrates a calculation of the risk intensity of the dynamic risk area range DRR. FIG. 2A is a schematic diagram of the dynamic risk area range DRR according to some embodiments of the present disclosure. As shown in FIG. 2A, a position of the vehicle system 200 (i.e., a vehicle position) is located on the middle lane. The dynamic risk area range DRR can be determined by the vehicle position and a vehicle speed of the vehicle information 202 transmitted by the vehicle system 200 to the cloud server 100, and together with a safety driving distance set by the government, but should not be limited thereto. In some embodiments, the standard for formulating the dynamic risk area range DRR can be set to be twice of the safety driving distance on both of front direction and rear direction of a sedan car.

Specifically, if the vehicle system 200 belongs to the sedan car, the safety driving distance between the sedan car and a vehicle in front thereof shall be kept at least at the speed of the sedan car (km/h) divided by 2 (with the SI unit directly converted to meters). That is, assuming that the speed of the sedan car is 100 (km/h), the sedan car must keep a safety driving distance of at least 50 meters from the vehicle in front thereof. Therefore, a length L of the dynamic risk area range DRR is formulated to be 200 meters, e.g., 100 meters in both the front and the rear of the sedan car (i.e., twice the safety driving distance), but should not be limited thereto. A length of a body of the vehicle may be ignored or additionally added so that the length L after the addition is slightly larger than the length L with the length of the body ignored. A width W of the dynamic risk area range DRR is generally the width W of the current lane multiplied by a number of lanes, that is, a total width WT of the road available for vehicle traffic. The formulation of the dynamic risk area range DRR as mentioned considers blind zones blocked by vehicles in the front and the rear of the host vehicle. Therefore, twice the safety driving distance is adopted. Certainly, the formulating method of the dynamic risk area range DRR is not limited to the above embodiment, and a formulator may adjust the formulating method of the calculation module 130 in the cloud server 100 as needed.

If the vehicle system 200 belongs to a large vehicle, the safety driving distance between the large vehicle and a vehicle in front thereof shall be kept at least at the speed of the large vehicle (km/h) minus 20 (with the SI unit directly converted to meters). That is, assuming that the speed of the large vehicle is 100 (km/h), the large vehicle must keep a safety driving distance of at least 80 meters from the vehicle in front thereof. Therefore, a length L of the dynamic risk area range DRR is formulated to be 320 meters, e.g., 160 meters in both the front and the rear of the large vehicle.

Reference is still made to FIG. 2A and also table 1 listed at the end of this paragraph. Table 1 lists a list of risk factor coefficients used to calculate the dynamic risk area range DRR in some embodiments of the disclosure. In FIG. 2A, six vehicles are exemplified, five of which have vehicle systems 200, 200-1, 200-2, 200-3, and 200-4 therein, respectively. The six vehicles are located in the dynamic risk area range DRR. The dynamic risk area range DRR is formulated by the cloud server 100 according to the vehicle position and the vehicle speed of the vehicle system 200. Assuming that the dynamic risk area range DRR has the following situation: the actual distance between the vehicle system 200-1 and the vehicle in front thereof is transmitted to the cloud server 100 and is determined as not keeping the driving safety distance, and the risk factor coefficient is set to be 1 when this risk factor occurs (situation 1); the vehicle speeds transmitted by the vehicle systems 200-2, 200-3 and the vehicle system 200 are determined by the cloud server 100 to be overspeed on the road section, and the risk factor coefficient is set to be 1 when this risk factor occurs (situation 2); and changes of position information with respect to time transmitted by the vehicle system 200-4 is determined by the cloud server 100 to be too high on the frequency of changing lanes, and the risk factor coefficient is set to be 1 when this risk factor occurs (situation 3). Although the present disclosure only exemplifies the situations where the risk factor coefficients are 1, the risk factor coefficients may also be assigned with different values (weighted values) with respect to different risk factors due to evolutions on big data statistics of traffic accidents.

TABLE 1

| Risk factor | Risk factor coefficient |
|---|---|
| Frequency of changing lanes | 1 |
| Not keeping safe driving distance | 1 |
| Overspeed | 1 |
| Emergency braking | 1 |
| Trigger frequency of tracking system | 1 |
| is too high | |
| Abnormal standard deviation of speed | 1 |
| Changing lanes without direction light | 1 |

In the hypothetical situation as mentioned, the number of vehicle in which the situation 1 occurs in the dynamic risk area range DRR is one, the number of vehicle in which the situation 2 occurs in the dynamic risk area range DRR is three, and the number of vehicle in which the situation 3 occurs in the dynamic risk area range DRR is one. Therefore, the risk intensity of the dynamic risk area range DRR is: 1(number of vehicle)×1(risk factor coefficient)+3(number of vehicle)×1(risk factor coefficient)+1(number of vehicle)×1(risk factor coefficient)=5. If the preset threshold of the determination module 140 of the cloud server 100 is 5, since the risk intensity calculated above is greater than or equal to the preset threshold, the cloud server 100 notifies a warning to the vehicle system 200 in real time through the communication module 110 that the risk intensity of the dynamic risk area range DRR is greater than the preset threshold. The warning may be that the on board unit 220 receives the warning from the cloud server 100, and then the on board unit 220 transmits the warning to the display module 230 to display the warning. The display module 230 is connected to the on board unit 220. The display module 230 may be an augmented reality head-up display (AR-HUD), but should not be limited thereto. The way the AR-HUD displays the warning may be marking both sides of the road with a specific color (e.g., red), or setting a supplementary warning sound to remind a user of the vehicle system 200.

Reference is made simultaneously to FIGS. 2A and 2B. FIG. 2B is a schematic diagram of the dynamic risk area range DRR moving synchronously with the vehicle system 200 in some embodiments of the present disclosure. FIG. 2B illustrates the position of the vehicle system 200 and the dynamic risk area range DRR at a specific time and a new position of the same vehicle system 200′ and a dynamic risk area range DRR′ of a next point in time (e.g., two seconds later) compared to the specific time. In the foregoing embodiments, instead of displaying a single risk event, the dynamic risk area range DRR is based on the risk intensity obtained by weighting the overall risk factor coefficients within a range. The risk intensity is the criterion for issuing a warning. Therefore, the user (driver) of the vehicle system 200 is free from being disturbed by too many warnings from each of the risk events, so as to achieve the real effect of the warning. The way of warning as mentioned resolves the situation in which too many warnings that cause fatigue on reactions of the user in many technical schemes of the existing scenario (e.g., the situation when too many potentially risky vehicles are present) occur, which substantially dilutes the warning effects. In addition, because the dynamic risk area range DRR is an appropriate range that is evaluated to effectively contain important blind zones, and the dynamic risk area range DRR is in real time advance with the vehicle position of the vehicle system 200 (as referred to FIG. 2B), the user of the vehicle system 200 can filter out information that is not closely relevant and receive the most important risk driving information, thereby further enhancing the actual effectiveness of the warning. For example, the risk information that a car accident occurred 20 kilometers away or a vehicle changes lanes too frequently 10 kilometers away have little effect on the current vehicle position of the vehicle system 200. Therefore, the aforementioned risk information will not be included in the warning range in the above embodiment.

Reference is made to table 2 as listed at the end of this paragraph. Table 2 lists correspondences between risk factors and risk factor coefficients with a detailed discretional table in some embodiments of the present disclosure. The table may be an exemplary condition that can be used to calculate the risk intensity described above, but should not limit the scope of the present disclosure. In some embodiments, when a vehicle changes lanes (number of changing lanes/time) too frequently, the vehicle will be bound with the risk factor coefficient equal to 1 within one minute. The standard of “too frequently” may be adjusted by the determination module 140 of the cloud server 100 according to needs, road conditions, vehicle conditions, etc. For example, the determination module 140 may adopts five times of changing lanes in one minute as the standard. In some embodiments, when a vehicle (host vehicle) does not keep a safety driving distance from a vehicle in front thereof (i.e., the safety driving distance is greater than the actual distance from the vehicle in front thereof), the vehicle (host vehicle) will be bound with the risk factor coefficient equal to 1 within one minute. For example, when the safety driving distance is set to be 200 meters (the vehicle speed may be 100 km/h at that time, but should not be limited thereto), if the actual distance to a vehicle in front thereof is 50 meters, the vehicle (host vehicle) will be bound with the risk factor coefficient equal to 1 within one minute.

TABLE 2

| | | Example of calculating |
|---|---|---|
| Risk factor | Illustration | risk factor coefficient |
| Frequency of | number of changing | changing lanes five |
| changing lanes | lanes/time | times within one minute: |
| | | risk factor coefficient = |
| | | 1; vehicle bound with |
| | | risk factor for five |
| | | minutes |
| Not keeping safety | safety driving | safety driving distance = |
| driving distance | distance > actual | 200 meters > actual |
| | distance between | distance between |
| | vehicles | vehicles = 50 meters: |
| | | risk factor coefficient = |
| | | 1 |
| Overspeed | speed > road speed | road speed limit = 100 |
| | limit | km/h, speed = 120 km/h: |
| | | risk factor coefficient = |
| | | 1 |
| Emergency braking | number of emergency | risk factor coefficient = |
| | braking > 0 (emer- | 1 |
| | gency braking is | |
| | prohibited on nation- | |
| | al highway) | |
| Trigger frequency of | number of triggering | tracking system is |
| tracking system is too | of tracking system/unit | triggered 30 times at the |
| high | time | same range of position |
| | | (e.g., area of 1 square |
| | | meter by GPS |
| | | positioning) within one |
| | | minute: |
| | | risk factor coefficient = |
| | | 1 |
| Abnormal standard | standard deviation of | standard deviation of |
| deviation of speed | speed > 20 within | speed > 20: |
| | specific area | risk factor coefficient = |
| | | 1 |
| Changing lanes with- | (omitted) | changing lanes without |
| out direction light | | direction light: |
| | | risk factor coefficient = |
| | | 1; vehicle is bound with |
| | | risk factor for one |
| | | minute |

In other embodiments, such as overspeed (e.g., the road speed limit is 100 km/h, and the actual vehicle speed is 120 km/h), emergency braking on the freeway, trigger frequency of the tracking system, the standard deviation of speed are too large compared to other vehicles on the same road section, and changing lanes without direction light, etc., all of the above can be set to be bound with the risk factor coefficient equal to 1 for a period of time (e.g., one minute). When a sum of the number of risk factor-related vehicles in the dynamic risk area range DRR multiplied by the risk factor coefficients is greater than the preset threshold, it is deemed to be a condition for triggering the warning. The determination of the risk factor coefficients as mentioned may be referred to information of the Freeway Bureau, Ministry of Transportation and Communications (MOTC) and the information is entered into the cloud server 100 (e.g., entering into the determination module 140) in advance, but should not be limited thereto.

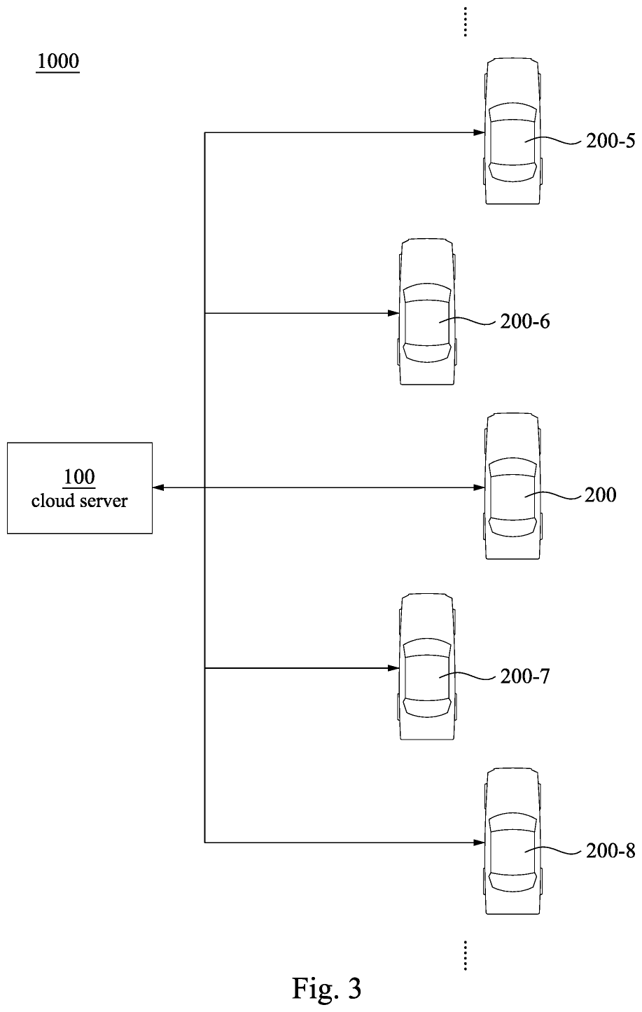

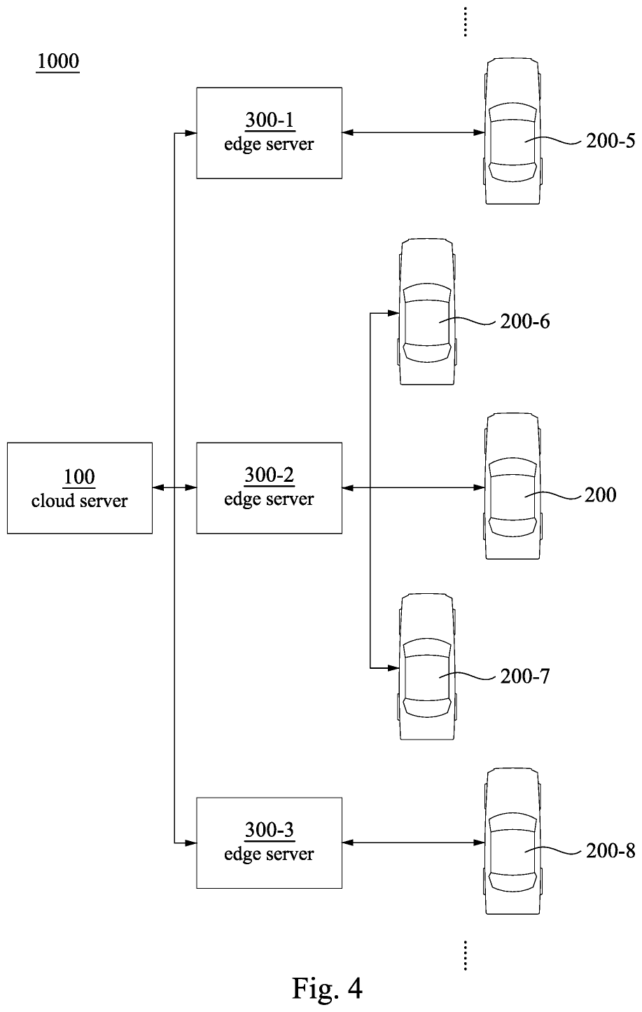

Reference is made to FIGS. 3 and 4. FIG. 3 is a schematic block diagram of the internet of vehicles system 1000 for dynamically marking risk area according to some embodiments of the present disclosure. FIG. 3 shows that in addition to the vehicle system 200 as shown in FIG. 1, a plurality of other vehicle systems 200-5, 200-6, 200-7, and 200-8 also communicate with the cloud server 100 in the same way as that of the vehicle system 200, so that each vehicle can receive real and complete risk information. FIG. 4 is a block diagram which further illustrates the vehicle systems 200, 200-5, 200-6, 200-7, and 200-8 communicating with the cloud server 100 via edge servers 300-1, 300-2, and 300-3 according to some embodiments of the present disclosure. The edge servers 300-1, 300-2, and 300-3 are configured for edge computing.

In the embodiments illustrated by FIG. 4, a vehicle to which the vehicle system 200-5 belongs moves to a place near a location of the edge server 300-1, vehicles to which the vehicle systems 200, 200-6, and 200-7 belong move to a place near a location of the edge server 300-2, and a vehicle to which the vehicle system 200-8 belongs moves to a place near a location of the edge server 300-3. Since the edge servers 300-1, 300-2, and 300-3 process data near the data collection spots, the loading of the cloud server 100 can be reduced. In the meantime, the capability of real time data processing can be enhanced, and the response time is increased. With the cooperation of the edge servers 300-1, 300-2, and 300-3 and the cloud server 100, edge computing can be used to process a large amount of real-time information (e.g., vehicle information 202 in the embodiments mentioned above), and then the cloud server 100 accesses the edge servers 300-1, 300-2, and 300-3 to further sort and calculate the real-time information so as to provide customized information or a warning service to the vehicle system 200. Communications among the edge servers 300-1, 300-2, and 300-3, the cloud server 100, and the vehicle system 200 can be achieved by standard communication technology for internet of vehicle, such as the R16 standard, but should not be limited thereto.

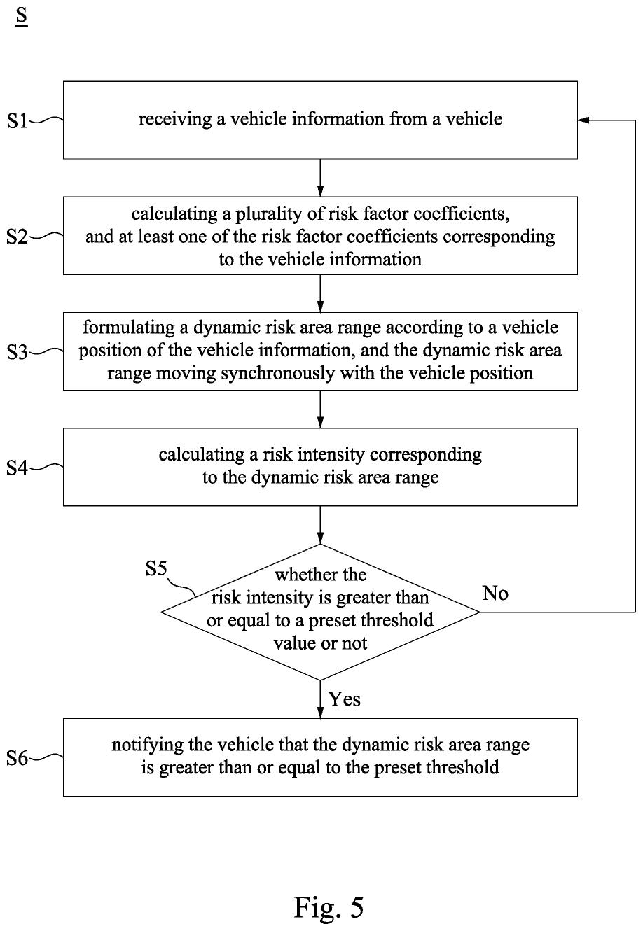

Reference is made to FIG. 5. FIG. 5 is a schematic flowchart of a method S for dynamically marking risk area according to some embodiments of the present disclosure. The method S for dynamically marking risk area may be implanted by the internet of vehicles system 1000, but should not be limited thereto. The method S for dynamically marking risk area includes the following steps of: receiving vehicle information 202 from a vehicle system 200 (step S1); calculating a plurality of risk factor coefficients, and at least one of the risk factor coefficients corresponding to the vehicle information 202 (step S2); formulating a dynamic risk area range DRR according to a vehicle position of the vehicle information 202, and the dynamic risk area range DRR moving synchronously with the vehicle position (step S3); calculating a risk intensity corresponding to the dynamic risk area range DRR, and the risk intensity being formed by weighted sum of the risk factor coefficients (step S4); and determining whether the risk intensity is greater than or equal to a preset threshold value (step S5), if the determination is “YES”, the vehicle system 200 is notified of a warning that the dynamic risk area range DRR is greater than or equal to the preset threshold (step S6). In some embodiments, when the risk intensity is determined to be smaller than the preset threshold value (i.e., determined to be “NO”), continue to receive the vehicle information 202 from the vehicle system 200, that is, returning to step S1. In some embodiments, the vehicle information 202 further includes a frequency of changing lanes, a condition of keeping safety driving distance, a vehicle speed, a vehicle acceleration, an emergency braking, a trigger frequency of a tracking system, or whether a direction light being switched on while changing lanes. All of the vehicle information 202 as mentioned can be used to determine the risk factor of the vehicle, so as to make the derived risk intensity of the dynamic risk area range DRR more accurate.

In summary, the embodiments of the present disclosure provide an internet of vehicles system and a method for dynamically marking a risk area that can formulate a real time risk area range for vehicles and calculate a real time risk intensity corresponding to the risk area range. Since the technical scheme of the present disclosure is to issue warnings by considering risk factor coefficients based on “peripheral area” of the vehicle rather than independent risk events, distractions of drivers due to frequent warnings can be avoided. Therefore, the benefit of reminding risk warnings to the drivers is realized, and the purpose of safety driving can still be achieved or even increased.

Various systems, modules, units, and devices in the embodiments of the present disclosure may be software, hardware, or a combination of software and hardware, and may be operated in the manner of processors and memories. The processors and memories can be configured to allow usage of internet, internal network, WAN, LAN, dedicated short range communication (DSRC), cellular vehicle-to-everything (C-V2X), LTE-V2X, 5G-V2X and other frameworks, and can be executed across systems or platforms. Processors can execute computer executable program instructions stored in memories. Processors may include hardware such as microprocessors and application specific integrated circuits (ASIC), but should not be limited thereto. The “connected” as mentioned in the present disclosure may be connected by wire or wireless.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An internet of vehicles system for dynamically marking risk area, comprising:
a cloud server configured to communicate with a vehicle system, the cloud server comprising:
a communication module configured to receive vehicle information from the vehicle system, and the vehicle information comprising a vehicle position;
a planning module configured to formulate a dynamic risk area range according to the vehicle position, and the dynamic risk area range moves synchronously with the vehicle position;
a calculation module configured to calculate a plurality of risk factor coefficients and to calculate a risk intensity corresponding to the dynamic risk area range, wherein one of the plurality of the risk factor coefficients corresponds to the vehicle information and the risk intensity is formed by weighted sum of the plurality of the risk factor coefficients; and
a determination module configured to determine whether the risk intensity is greater than or equal to a preset threshold value,
wherein when the risk intensity is greater than or equal to the preset threshold value, the communication module notifies a warning to the vehicle system that the risk intensity of the dynamic risk area range is greater than the preset threshold value.

2. The internet of vehicles system of claim 1, wherein the cloud server further comprises:
a temporary storage module connected to the calculation module and configured to provide another vehicle information of another vehicle to the calculation module, so that the calculation module integrates and calculates to derive the risk intensity corresponding to the dynamic risk area range.

3. The internet of vehicles system of claim 1, wherein the vehicle information further comprises a frequency of changing lanes, a condition of keeping safety driving distance, a vehicle speed, a vehicle acceleration, an emergency braking, a trigger frequency of a tracking system, or whether a direction light being switched on while changing lanes.

4. The internet of vehicles system of claim 1, wherein when the risk intensity is determined to be smaller than the preset threshold value by the determination module, the communication module continues to receive the vehicle information from the vehicle system.

5. A method for dynamically marking risk area, comprising:
receiving vehicle information from a vehicle system;
calculating a plurality of risk factor coefficients, and at least one of the plurality of the risk factor coefficients corresponding to the vehicle information;
formulating a dynamic risk area range according to a vehicle position of the vehicle information, and the dynamic risk area range moving synchronously with the vehicle position;
calculating a risk intensity corresponding to the dynamic risk area range, the risk intensity being formed by weighted sum of the risk factor coefficients; and
determining whether the risk intensity is greater than or equal to a preset threshold value, and notifying a warning to the vehicle system that the risk intensity of the dynamic risk area range is greater than the preset threshold value.

6. The method of claim 5, further comprising displaying the warning that the risk intensity of the dynamic risk area range is greater than the preset threshold value on a display module of the vehicle system.

7. The method of claim 5, further comprising continuing to receive the vehicle information from the vehicle system when the risk intensity is determined to be smaller than the preset threshold value.

8. The method of claim 5, wherein the vehicle information further comprises a frequency of changing lanes, a condition of keeping safety driving distance, a vehicle speed, a vehicle acceleration, an emergency braking, a trigger frequency of a tracking system, or whether a direction light being switched on while changing lanes.
